(19) United States
(12) Patent Application Publication
(10) Pub. No.: US 2016/0350835 A1
(43) Pub. Date: Dec. 1, 2016

(54) System and method for finding possible bartering partners in both two-party and multi-party scenarios via smartphone/mobile device application.

(71) Applicants: Dan Rittman, San Diego, CA (US); Aliza Schnapp, Beverly Hills, CA (US)

(72) Inventors: Dan Rittman, San Diego, CA (US); Aliza Schnapp, Beverly Hills, CA (US)

(21) Appl. No.: 14/545,577

(22) Filed: May 26, 2015

(51) Int. Cl. G06Q 30/06

(52) U.S. Cl. CPC G06Q 30/0633

(57) ABSTRACT

This paper describes a computerized based system and method invention for trade-in bartering items between two or more parties using smartphone/mobile device application. All parties access a central server via smartphone/mobile device application and provides a list of items they have to trade-in and want to obtain, a description of the items and any conditions for trade-in of the items. The lists are stored in a database to indicate the party's possible trades are automatically created. A heuristic based system checks for possible trades between the parties. In case a match was found the parties involved in each possible trade are notified to suggest the trade. Upon receipt of confirmation from each party, the trade is processed to completion.

### TECHNICAL FIELD OF THE INVENTION

The present invention relates generally to a method and system for finding potential barter/trade-in transactions between two or more parties and more specifically, to a method and system capable of determining matches between two or more parties via smartphone/mobile device application computer software.

### FIELD AND BACKGROUND OF THE INVENTION

Smartphone/mobile device application system comprises a vast number of application software, web servers and computers, which themselves are joined together by means of switches, routers, base stations, and wireless gateways that collectively enable transfer of packets of data between smartphones/mobile devices and computers using various networking protocols. The interconnected web servers and computers exchange information using various standard and non-standard services, such as electronic mail (or email), ftp, and the Hypertext Transfer Protocol (HTTP). In view of its open protocol nature, the Internet facilitates unprecedented instant interconnections between clients, companies, and governments that were not even dreamed of a decade ago.

With the invention of the wireless communication, new global business opportunities have surfaced. In view of its global nature, the mobile world is especially useful for conducting electronic commerce.

Many smartphone/mobile device applications have been developed and utilized by vendors to advertise and sell products. The products can be tangible items (e.g., books, CD's, collectibles, etc.) that are delivered through conventional distribution channels (e.g., a common mail carrier), items that are delivered electronically to the purchaser over mobile devices and/or smartphones/mobile device, or items that are electronically confirmed only (e.g., rights of use timeshare). Mobile commerce does not only copy the brick and mortal storefront to extend its reach to global markets, it has also enabled the birth of new businesses that would not be possible to form without the capability of reaching millions of clients.

Besides a traditional mobile marketplace's sell and purchase transactions, a smartphone/mobile device application system may also be built to provide an electronic version of classified advertisements or classifieds. Such systems list items that are available for sale, purchase, and/or trade. In the past, classifieds were traditionally in print media at local newspapers or posted at, for example, local supermarkets or clubs. With the advent of the mobile world, an electronic bulletin board and classifieds can grow to include clients outside of a local area.

For example, in a typical mobile application bulletin board or classifieds model, a client who wishes to offer an item for sale may list one or more items he owns on the web site. This listing information may include, among others things, the seller's name, address, email address, and telephone number and possibly credit card number or other payment account if a listing fee is charged. Another client, who is a potential buyer, may browse through the electronic bulletin board using the Internet and a web browser over the smartphone/mobile device system and select various items that he wishes to buy. In one implementation, once the other client selects the items, the actual sale/purchase is accomplished outside of the electronic platform. In another implementation, when the client has completed selection of the items to be purchased, the mobile application then prompts the potential buyer for additional information, such as shipping information and a credit card number, in order to complete the trade. The smartphone/mobile device application then typically confirms the order by sending a confirming text or email to the client computer system and informs the seller to ship the item.

Although this traditional “electronic bulletin board” or “classifieds” model is very flexible and intuitive, it has several major downsides. It can facilitate a sale or purchase of items independent of each other only, but not for barter. In other words, only one transaction, sale, or purchase, at a time is executed. In addition, although some more advanced “electronic bulletin boards” allow clients to specify items for barter, they allow specifying only one item wanted for each item available. The inability to specify multiple “Want” items for each item listed makes trade transactions difficult to complete.

It is believed that existing smartphone/mobile device based “electronic bulletin boards” do not support trade-in or bartering between a plurality of clients and items. Most, if not all, such existing mobile applications do not have any efficient automated matching capability to find potential trades. Although a manual search for potential trades involving only two participants is, in general, feasible, search for multiparty trades and coordinating of multiparty barter without automated tools is, at least, cumbersome. Since the overhead of searching for potential trade partners can be very high, a computerized barter matching system would be desirable for fast matching of trader's items without providing “repeated” information for each matching step.

Since assignment of multiple “Want” items is accomplished during an initial description of the item available, the assignment of multiple “Want” items for this one particular item available is initially declared as the “default” assignment or “connection”. However, during each individual client's session in which the client is using the system to match his items for trade, the client may temporarily decide to change “Want” items for his item available. In other words, if default linked “Wants” can be temporarily changed for the duration of the matching session, clients will be able to find other potential trades that would not be available if the default trade request assignment is used. Therefore, it is desirable to enable clients to further modify assignments of multiple “Want” items for each item listed during the time the client is engaged in online matching activity.

If, during the session of finding the trading partners for items available, the match results are not found, the clients may be interested in finding at least the (i) clients who want their item and/or (ii) clients who have what the client wants for his item. A system is therefore needed to allow clients to find one or more matches for their available items as well as to provide a list of clients or items available for trade that do not match client's “Want” list thus allowing the client to initiate the trade with an unwanted item or offer the different item for the wanted item.

In a typical smartphone/mobile device application electronic bulletin board, the client, who is a potential buyer, has limited search capabilities for items he is interested in acquiring. A returning client, typically regarded as a “guest” until log-in, cannot search for items he is interested in without specifically describing search conditions each time they are conducting a search. A system would therefore be desirable that allows clients to find one or more matches for items of interest without logging into the system by automated means thereby offering the client potential matched trades in a batch mode, for example, once a day, once a week, etc.

Although the matching system utilizing the detailed description and categorization of items available for trade and items wanted can provide adequate “suggestions” as to potential trades available, the matching system may further be augmented with information about the client's behavior as it relates to his current and/or past trading activity. The information about the client's trading behavior may be beneficial in the selection of potential trading partners. It would therefore be desirable to enable the system to allow utilization of clients' trading behavior in order to find eventual trading partners for items available and items wanted.

The above-mentioned methods that allow traders to save time and money by shortening the process of finding potential trades clearly constitute an important enabling factor for further advances in e-Commerce. As described more fully below, the present invention improves the prior art e-Commerce mobile application-based barter systems by proposing, among other things, a system that automatically matches potential trade partners that are likely to agree with a barter transaction. It would therefore be of great interest to e-Commerce participants to use systems that embody the present invention while trying to improve their efficiency and profitability.

### SUMMARY OF THE INVENTION

The invention describes methods and the system that allow parties to effectively find trading partners in a computerized classifieds listing system over smartphone/mobile device application.

It is an object of the present invention to provide a new method and system for finding “matches”, e.g., potential barter transactions between two or more parties each having one or more items available for barter and one or more items wanted for each individual item available, via smartphone/mobile device application.

It is another object of the present invention to provide a new method and system capable of finding multi-party “matches”, e.g., potential barter transactions between three or more parties using smartphone/mobile device application, which in some cases, overcomes deficiencies of current barter systems.

It is another object of the present invention to provide methods that increase both the accuracy and scope of match results thus allowing parties to find other barter alternatives.

In order to achieve one or more of these objects and possibly others, one embodiment of a method and system in accordance with the invention involves a computerized classifieds listing system for implementing and coordinating cashless barter between a plurality of trade parties each having one or more items available for barter, via smartphone/mobile device application, and or mobile application. In particular, the method and system enable a description of items offered for barter to be provided using smartphone/mobile device application, for efficient browsing and search within a barter database, for an automated matching and for creating potential two-party (2P) and multiparty (MP) trades.

In one embodiment, clients using the system and method enter data describing items they offer for barter, items they are willing to accept, and criteria regarding the trade, from the client's system to a central barter database residing, for example, on a central computer. In particular, they can describe items they offer for barter and items they are willing to trade without reference to other items in the database or by reference to items available for trade and items wanted.

### BRIEF DESCRIPTION OF THE DRAWINGS

The principles of the invention may be fully understood by reference to the following drawings, illustrating two embodiments of the present invention. Also, the invention may best be understood by reference to the following detailed description of and illustrative embodiment when read in conjunction with the accompanying drawings, wherein:

FIG. 1 shows a general architecture of the eBarter mobile application system in accordance with the invention; Multi-Parties offer their item to barter according to categories.

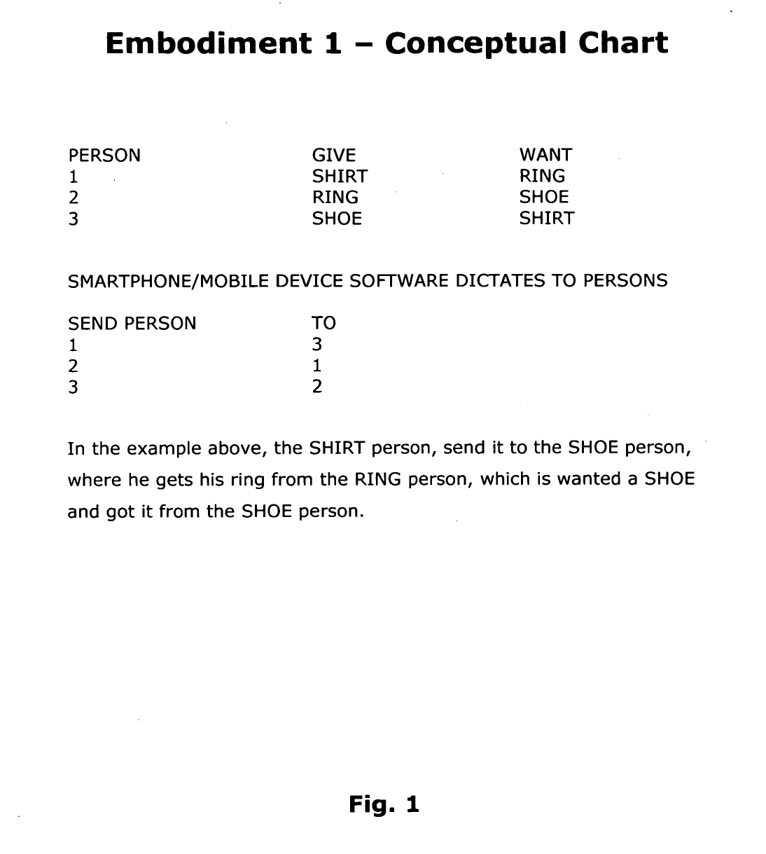

FIG. 2 is a screenshot showing the initial bartering categories concept in accordance with the invention. The mobile application offers wide variety of bartering categories. These categories offer users the option to place their item according to specific category.

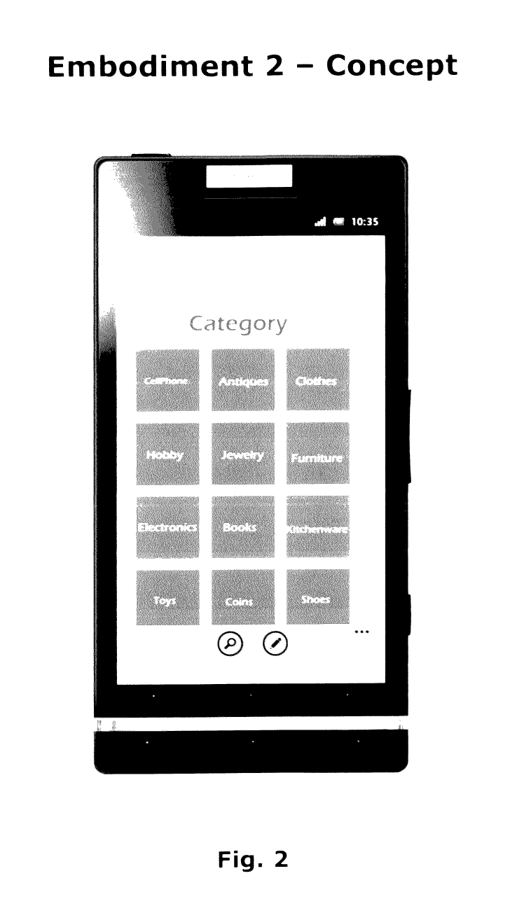

1. A method for bartering or trade-in items between two or more parties using smartphone/mobile device application communications, comprising: enabling each of the two or more parties to access via smartphone/mobile device application communications to provide a list of items a respective one of the two or more parties has to trade-in and a list of items a respective one of the two or more parties wants to obtain, wherein both the list of items the respective one of the two or more parties has to trade and wants to obtain is not limited to items previously listed in the system, and a description of the items and any conditions for trade of the items; storing the list of items each respective party has to trade and wants to obtain and a heuristic based engine as a matching engine database; automatically creating available database for both or more parties; automatically storing the directional item transfers in the matching engine database; conducting potential traders favorites and preferences study, making future conclusions; conducting via a heuristic based matching engine, the search for possible trades between the parties using the directional access via smartphone/mobile device application and; notifying the parties involved in each possible trade about the possible trade and requesting approval of the trade; and upon receipt of approval of the trade from each party listed in the possible trade, processing the trade to completion.

2. The method of claim 1, further comprising enabling each party to browse and search within the database via smartphone/mobile device application for possible trades involving items they have and/or items they want to obtain, and update the database relating to items they have to trade and want to obtain.

3. , The method of claim 1, further comprising: defining a heuristic based system with defined combinations of nodes, one for each party's item; associating one of a plurality of different vertexes with each node depending on whether the item is available for trade, related to the item or not related to any item listed; associating a directional edge between each vertex of an available item and a respective vertex related to the item or not related to any item listed; forming additional directional edges to interconnect nodes from different parties; and
considering the directional edges when conducting the search for possible trades using the heuristic engine by determining a route between a vertex of an available item and a vertex related to the item.

4. The method of claim 3, further comprising: assigning each vertex a specific mark relating to completeness of the item's description; sorting the routes of the possible trades based on the marks; and displaying the routes based on the marks.

5. The method of claim 1, wherein the step of conducting the search for possible trades between the parties using matching patterns includes searching for instant matches between only two parties having substantially similar or identical characteristics.

6. The method of claim 1, wherein the step of conducting the search for possible trades between the parties using mathematical marks includes searching for instant matches between three or more parties to form trading marks between the two, three or more parties.

7. The method of claim 1, further comprising displaying on a display to a party, potential trades immediately after entry by that party of a listing of an item for trade.

8. The method of claim 1, further comprising displaying on smartphone/mobile device application display to a party, items sought by at least one other party for an item sought by that party after entry by that party of a listing of an item for trade.

9. The method of claim 1, further comprising storing in database, a history of each party's trades and marks, the search for possible trades between the parties using the characteristics being conducted in consideration of the parties' trading history, displayed on a smartphone/mobile device application.

10. The method of claim 1, further comprising: storing in database, a history of each party's possible and actual trades; and adjusting the marks based on the party's trading history, the search for possible trades between the parties using heuristic study characteristics being conducted by the smartphone/mobile device application in consideration of the parties' trading history and the marks.

11. A system for bartering trade-in items between two or more parties using a smartphone/mobile device application communications, comprising: a central server; at least one network interface; a plurality of smartphones/mobile devices connected to the central server via central computer software, each through at least one communications and the at least one network interface; said central server comprising a web server; at least one application server/processor; and at least one database, the central server being arranged to: enable each of the two or more parties to access a server via smartphone/mobile device application communications network to provide a list of items a respective one of the two or more parties has to trade and a list of items a respective one of the two or more parties wants to obtain, wherein both the list of items the respective one of the two or more parties has to trade and wants to obtain is not limited to items previously listed in the system, at least one directional connection for each of the two or more parties relating at least one item to trade of the respective one of the two or more parties and at least one item to obtain of the respective one of the two or more parties, automatically create using the at least one application server/processor, directional item transfers indicating the respective party's possibility to acquire items in trades including a trade of a single item for another single item, a trade of a plurality of items for a single item, a trade of a single item for a plurality of items, and a trade of a plurality of items for a plurality of items, automatically store the directional item transfers in the matching engine database, assigning weights to the connections that represents a degree of similarity between descriptions of items available for trade and wanted items, the search for possible trades between the parties being conducted in consideration of the marks of the connections, conduct a search for possible trades between the parties using the directional connections and directional item transfers represented as closed loops of interconnected directional connections and directions item transfers thus avoiding a repetitive and time consuming database search of each recursive step; notify the parties involved in each possible trade about the possible trade and requesting approval of the trade; and upon receipt of approval of the trade from each party listed in the possible trade, process the trade to completion.

12. The system of claim 11, wherein the at least one database contains (i) barter listings with connections between items offered in trade and items wanted, (ii) barter offers and their status, and (iii) a barter archive containing all previously posted, but not longer active barter listings, offers, and trades.

13. The system of claim 11, wherein the at least one application server/processor comprises a first smartphone/mobile device application server/processor and a second application server/processor and the at least one database comprises a first database associated with the first application server/processor and a second database associated with the second application server/processor, said first application server/processor being arranged to determine a degree of similarity between items associated with the connections, the second application server/processor being arranged to identify possible barter transactions based the marks with associated degree of similarity.

14. The system of claim 13, wherein the first application server/processor is arranged to assign mathematical marks to the connections representing the degree of similarity between items associated with user's requests, and the second application server/processor is arranged to consider the marks of the connections when determining possible barter transactions.

15. The system of claim 11, wherein the central server is arranged to search for possible trades between the parties using the marks by searching for instant matches between only two parties having substantially similar or identical connections derived by the heuristic system.

16. The system of claim 11, wherein the central server is arranged to search for possible trades between the parties using heuristic study information by searching for instant matches between three or more parties to form a trading circle of marks between the three or more parties.

17. The system of claim 11, wherein the at least one database further includes a history of each party's trades, the central server being arranged to search for possible trades between the parties using the connections in consideration of the parties' trading history.

18. The system of claim 11, wherein the central server is using heuristic, study database as a basis for traders match.

19. The system of claim 18, wherein the heuristic engine is constantly processing traders information in order to perform best match between two or more parties.
